(19) United States
(12) Patent Application Publication
(10) Pub. No.: US 2008/0266446 A1
(43) Pub. Date: Oct. 30, 2008

(54) AUDIOVISUAL CAPTURE DEVICE

(76) Inventors: Shyh-Yih Ma, Taipei (TW); Jen-Chih Wu, Taoyuan (TW); Chao-Tan Huang, Yung-he City (TW)

Correspondence Address: RABIN & BERDO, P.C.;Suite 500, 1101 14 Street, N.W., Washington, DC, 20005, US

(21) Appl. No.: 11/954,084

(22) Filed: Dec. 11, 2007

(30) Foreign Application Priority Data
Apr. 30, 2007 (TW) 096115237

(51) Int. Cl. H04N 5/225

(52) U.S. Cl. 348/372; 348/E05.024

(57) ABSTRACT

An audiovisual capture device, with its special structural design, can be installed on a lamp socket or a power socket, and is assembled or formed with an electric assembly part at one end of the audiovisual capture device, allowing the audiovisual capture device to be assembled at the lamp socket or the power socket by using this electric assembly part, so as to achieve functions of fixing and of conducting electric current, at a same time. In addition, electronic signals can be transmitted by using the lamp socket or the power socket, simultaneously.

### BACKGROUND OF THE INVENTION

a) Field of the Invention

The present invention is related to an audiovisual capture device for capturing sounds or images, and, more particularly, to an audiovisual capture device that uses an electric component to achieve fixation and electrical connection at the same time.

b) Description of the Prior Art

The surveillance camera is widely used these days, and is gradually entering into our daily life. However, for a user who does not have installation skill, it is not easy for one who wants to install the surveillance camera by itself. If the user wants to install the camera at home by itself, then he or she has to prepare and handle a lot of professional tools, such as an electric drill, a cable stripper, etc. Most of the ordinary users do not have these kinds of tools. Moreover, even if a basal stand is installed, during the process for connecting the body of the surveillance camera to the basal stand, since the location of the joint is usually difficult to be seen and an aperture of the joint is rather narrow, it often results in an ill alignment. Besides, as the surveillance camera is usually installed on a wall, a power line and other wirings of the camera will also cause a large change to views in a home, after installation.

Accordingly, to avoid the aforementioned troubles, the user usually needs to ask for help from professional engineers, which brings inconvenience and extra costs to the consumers. In an existing building structure, a lot of lamp sockets and power sockets exist on walls, and corresponding wirings are buried in the walls. Referring to FIG. 1, it shows a schematic view in assembling a conventional screw-type lamp socket and a lamp. As shown in the drawing, a screw-type lamp socket 10, which is commonly assembled on a ceiling, is provided with an electric assembly hole 101 into which a lamp 102 is screwed by its electric assembly part 1021, and is electrically connected with the screw-type lamp socket 10 using the electric assembly part 1021 and an electrical contact 1022 at a tail end, so as to achieve a function of conducting electric current. Accordingly, after the electric current is conducted, the lamp 10 will generate light. In addition, as this kind of screw-type lamp socket 10 is emplaced in most buildings, if the screw-type lamp socket 10 can be used properly, then the audiovisual capture device can be assembled more easily.

### SUMMARY OF THE INVENTION

Accordingly, the primary object of the present invention is to provide an audiovisual capture device which can be installed by using an existing lamp socket or power socket. The audiovisual capture device described by the present invention could be a camera, or a network camera, etc., and an assembly end of the audiovisual capture device is installed with an electric assembly part which is provided with a fixing function and a function for conducting electric current. Therefore, an installer only needs to plug the electric assembly part of this audiovisual capture device into the power socket or the lamp socket, and the audiovisual capture device can be fixed. At the same time, the audiovisual capture device is electrically connected with the lamp socket, and can operate after conducting the electric current. Moreover, if the audiovisual capture device is a network camera, then an electronic signal can be transmitted through a circuit connected by the lamp socket.

To enable further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic view in assembling a conventional screw-type lamp socket with a lamp.

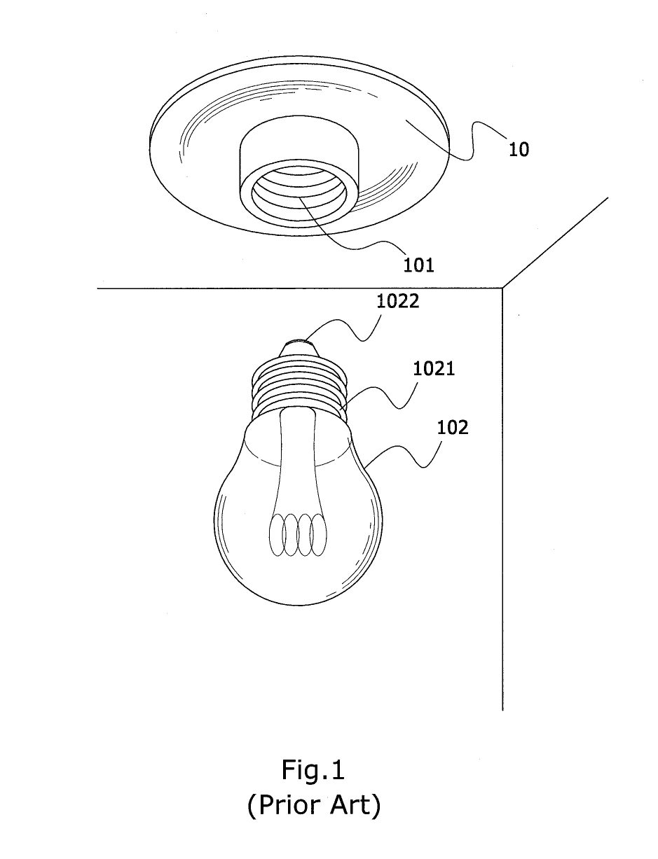

FIG. 2 shows a perspective view of the present invention.

FIG. 3 shows a first schematic view of an implementation of the present invention.

FIG. 4 shows a second schematic view of an implementation of the present invention.

FIG. 5 shows a schematic view of a first preferred embodiment of the present invention.

FIG. 6 shows a rear view of a first preferred embodiment of the present invention.

FIG. 7 shows a schematic view of a second preferred embodiment of the present invention.

FIG. 8 shows a schematic view of a third preferred embodiment of the present invention.

### DETAILED DESCRIPTION OF THE PREFERRED EMBODIMENTS

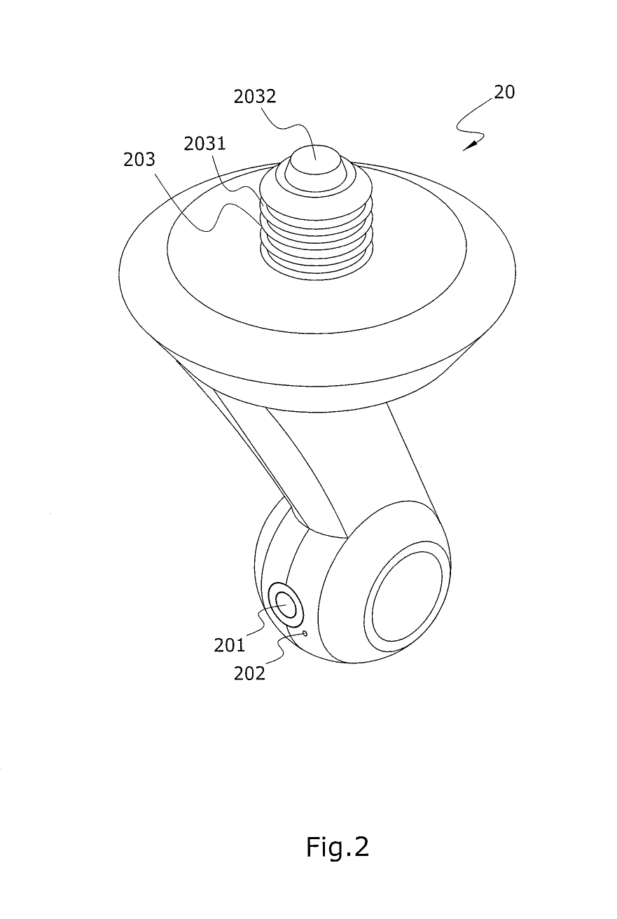

Referring to FIG. 2, an audiovisual capture device 20 is primarily constituted by an image capture part 201, a sound capture part 202, and an electric assembly part 203, wherein the image capture part 201 can capture static and dynamic images, and the sound capture part 202 can capture sounds in a site. Moreover, according to a real requirement, the electric assembly part 203 can be configured as a two-pin, three-pin, or screw-type lamp socket. An embodiment disclosed by the present invention is a screw-type electric device part, its surface is formed with threads 2031, and the tail end of the electric assembly part 203 is formed with an electrical contact 2032.

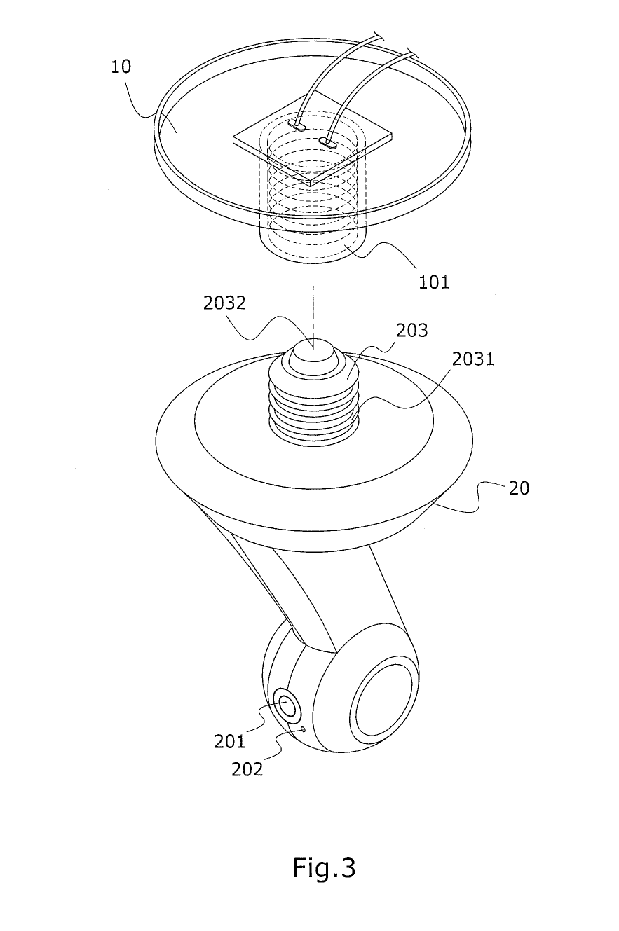

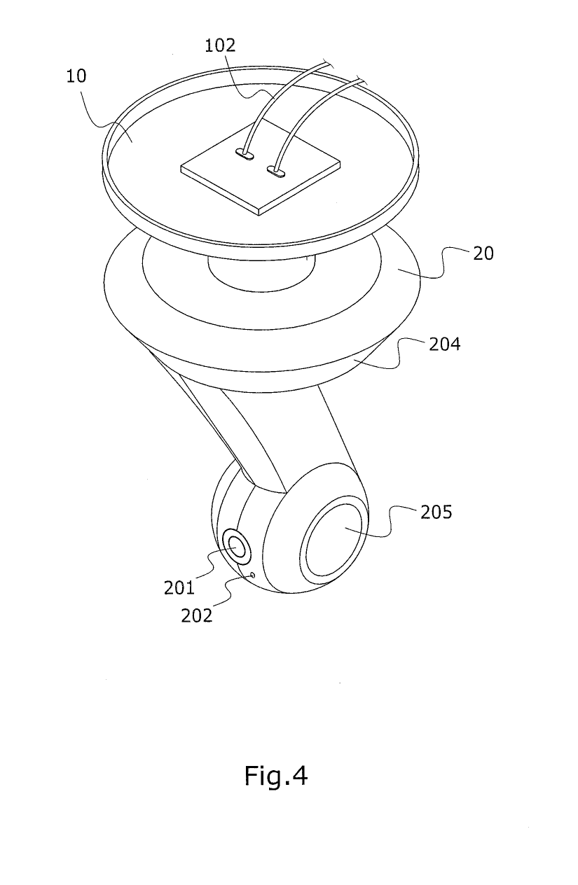

Referring to FIG. 3, the audiovisual capture device 20 of the present invention is screwed into an electric assembly hole 101 of a screw-type lamp socket 10 by the threads 2031 of the electric assembly part 203, such that the audiovisual capture device 20 can be fixed well. Furthermore, after screwing, as surfaces of the threads 2031 are provided with electrical conductivity, the threads 2031 can be electrically connected with one polarity of the electric assembly hole 101 of the screw-type lamp socket 10, whereas the electrical contact 2032 at the tail end of the electric assembly part 203 is electrically connected with another polarity of the electric assembly hole 101. Therefore, when the audiovisual capture device 20 is screwed, it can be fixed and electrically connected at a same time, as shown in FIG. 4. Referring to FIG. 4, when the audiovisual capture device 20 is screwed into the screw-type lamp socket 10, it will be effectively fixed on a ceiling (not shown in the drawing), and at a same time is electrically connected. Therefore, when the electric current is conducted, the audiovisual capture device 20 can operate. On the other hand, images or sound signals captured by the image capture part 201 or the sound capture part 202 can be transmitted to an operation device at the other end, such as a computer or a monitor, through the wiring 102 of the screw-type lamp socket 10. As shown in the drawing, in order to have an optimal capturing angle, at least one horizontal rotating shaft 204 or even a vertical rotating shaft 205 can be assembled in the structure of the audiovisual capture device 20. In this way, after assembling the audiovisual capture device 20, a capturing location can be still fine tuned, to more comply with a practical usage.

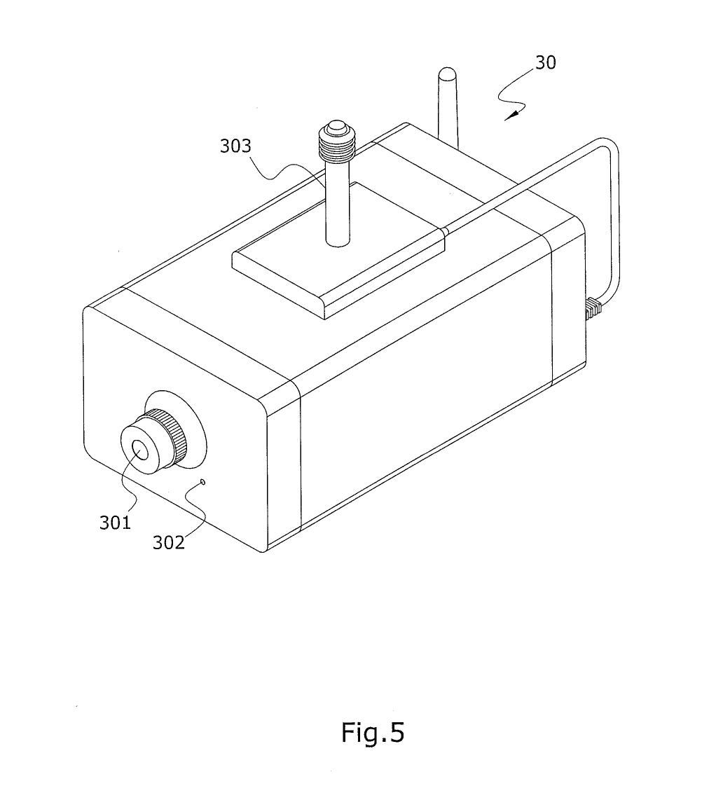

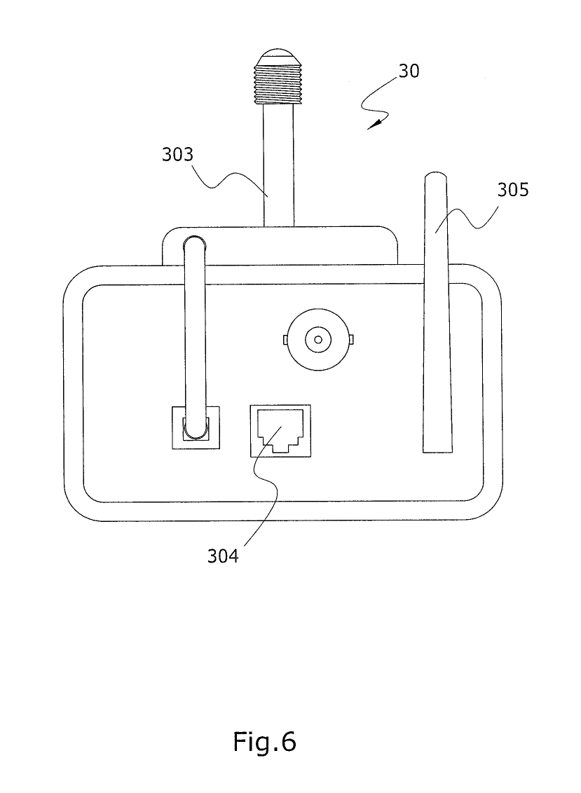

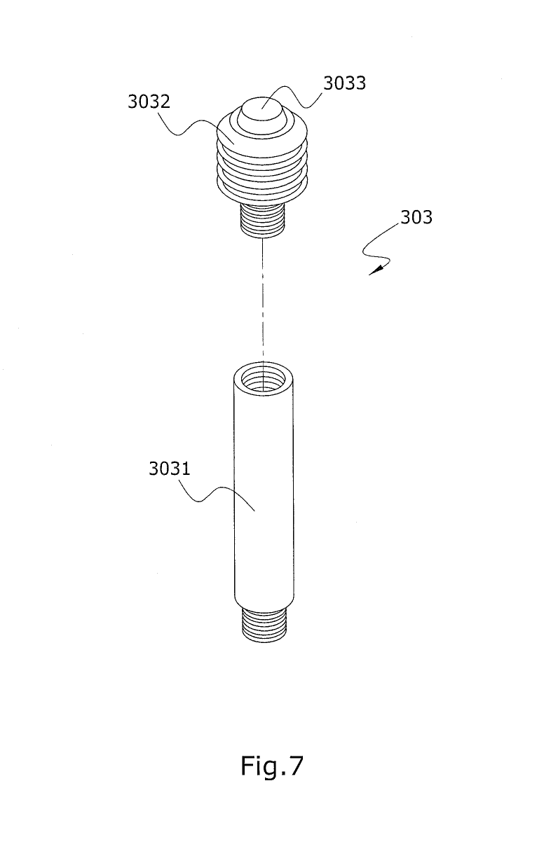

Referring to FIG. 5, it shows another preferred embodiment of the present invention, wherein an audiovisual capture device 30 is a network camera which can be connected with a network, and is suitable for remote monitoring. The audiovisual capture device 30 comprises primarily an image capture part 301, a sound capture part 302, and an electric assembly part 303. As shown in the drawing, and also referring to FIG. 7, the electric assembly part 303 is constituted by an extension rod 3031 and a screw connector 3032, wherein a surface of the screw connector 3032 provides for conducting the electric current, and a tail end of the screw connector 3032 is formed with an electrical contact 3033. Referring to FIG. 6, the audiovisual capture device 30 is provided with at least one network connection module, such as a network line connection port 304 and a wireless network module 305, for providing a wired or a wireless network connection depending on an actual requirement, upon installing the audiovisual capture device. As shown in FIG. 5 again, the audiovisual capture device 30 is screwed into a screw-type lamp socket by using the screw connector 3032 of the electric assembly part 303, enabling the audiovisual capture device 30 to be fixed and electrically connected. Moreover, the network line connection port 304 whose rear end can provide for connecting to a network after plugging in with a network line, or can accomplish a connection to a wireless network using the wireless network module 305, so as to achieve a function of remote monitoring.

Referring to FIG. 7, the extension rod 3031 and the screw connector 3032 of the electric device part 303 are formed individually, and then they are assembled by male and female threads, with a primary object of using a length of the extension rod 3031 to enable the audiovisual capture device 30 to comply with an onsite installation requirement

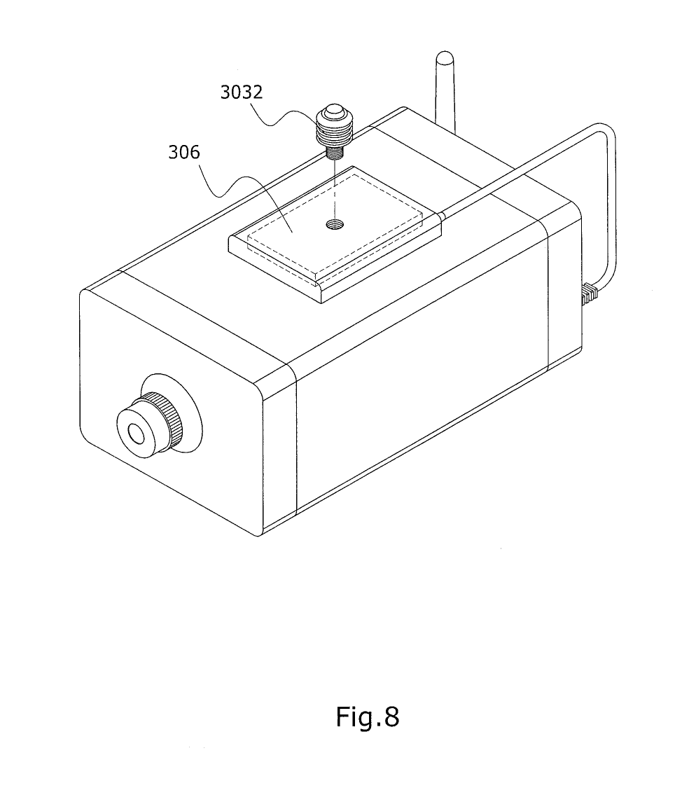

Referring to FIG. 8, the screw connector 3032 can be directly assembled on the audiovisual capture device 30, whereas the other end can be directly assembled on the screw-type lamp socket. On the other hand, as shown in the drawing, the screw connector 3032 can be assembled at a transformer 306 of the audiovisual capture device 30, allowing the transformer 306 to be electrically coupled with the screw connector 3032, and to be assembled with the screw-type lamp socket.

Accordingly, the audiovisual capture device described by the present invention is provided with a function of capturing images, sounds, or both, such as an analog camera, a digital camera, or a network camera. The audiovisual capture device comprises primarily an electric assembly part, such that the audiovisual capture device can be quickly assembled with a lamp socket or power socket. Functions of fixing and electrical connection can be achieved at the same time after assembling. In addition, by the connection with the power socket, electronic signals can be transmitted by using a circuit layout of the power socket. Accordingly, after implementation, the present invention truly provides an audiovisual capture device which can be installed by using an existing lamp socket or a power socket, so as to effectively simplify a procedure for installing and assembling hardware, thereby enabling the audiovisual capture device to be more practical.

Of course it is hard to be understood that the embodiments of the invention described herein and that a wide variety of modifications thereto may be effected by persons skilled in the art without departing from the spirit and scope of the invention as setting forth in the following claims.

What is claimed is:

1. An audiovisual capture device, which is assembled at a power socket for supplying power, comprising an image capture part which is used to capture images; and an electric assembly part, one end of which is assembled at said image capture part and is electrically connected with said image capture part, and the other end of which is assembled with said power socket, allowing said image capture part to be fixed and electrically connected.

2. The audiovisual capture device according to claim 1, wherein said electric assembly part is formed with threads to be assembled with said power socket which is formed as a screw-type lamp socket.

3. The audiovisual capture device according to claim 2, wherein said surface of the threads that are formed on said electric assembly part is provided with electrical conductivity, whereas a tail end of said electric assembly part is formed with an electrical contact.

4. The audiovisual capture device according to claim 2, wherein said electric assembly part is assembled with an extension rod.

5. The audiovisual capture device according to claim 1, wherein a horizontal rotating shaft is assembled between said image capture part and said electric assembly part.

6. The audiovisual capture device according to claim 1, wherein said image capture part is assembled at a vertical rotating shaft.

7. The audiovisual capture device according to claim 1, wherein a network connection port is further provided, for making a network connection to said audiovisual capture device by a network line.

8. The audiovisual capture device according to claim 1, wherein a wireless network module is further provided.

9. The audiovisual capture device according to claim 1, wherein said end of said electric assembly part that is plugged into said power socket is a two-pin type.

10. The audiovisual capture device according to claim 1, wherein said end of said electric assembly part that is plugged into said power socket is a three-pin type.

11. The audiovisual capture device according to claim 1, wherein said electric assembly part is coupled with a transformer in the audiovisual capture device.
